(19) United States
(12) Patent Application Publication
(10) Pub. No.: US 2024/0298193 A1
(43) Pub. Date: Sep. 5, 2024

(54) TRAINING A MACHINE LEARNING MODEL TO IDENTIFY A RELATIONSHIP BETWEEN DATA ITEMS

(71) Applicant: Telefonaktiebolaget LM Ericsson (publ), Stockholm (SE)

(72) Inventors: Yimin NIE, Montreal (CA); Xiaoming LI, Montreal (CA)

(21) Appl. No.: 18/574,400

(22) PCT Filed: Jul. 1, 2021
(86) PCT No.: PCT/IB2021/055913

§ 371 Date: Dec. 27, 2023

(51) Int. Cl. H04W 24/02; H04L 43/0805

(52) U.S. Cl. CPC H04W 24/02; H04L 43/0805

(57) ABSTRACT

There is provided a computer-implemented method for processing data items for use in training a machine learning model to identify a relationship between the data items. The data items correspond to one or more features of a telecommunications network. For each feature of the one or more features, the corresponding data items are organised into a sequence according to time to obtain at least one sequence of data items. A single sequence of data items having the at least one sequence of data items is encoded to obtain an encoded sequence of data items. The single sequence of data items is encoded with information indicative of a position of data items in the single sequence of data items. The encoded sequence of data items is for use in training the machine learning model to identify the relationship between the data items.

### TECHNICAL FIELD

The disclosure relates to a computer-implemented method for processing data items for use in training a machine learning model to identify a relationship between the data items, a computer-implemented method for training the machine learning model to identify the relationship between the data items, and entities configured to operate in accordance with those methods.

### BACKGROUND

With an ever increasing demand for a fast-speed and high-quality user experience, it is important that a telecommunications network is able to serve large volumes of traffic (e.g. for online sessions) for a large number of end users of the network. In some scenarios, in order to assist with this, a network can be configured to deploy and allocate surrogate servers according to requests received from end users, e.g. via the online visit sessions of those end users.

A challenge that is associated with providing an optimum user experience is how to, automatically and efficiently, detect events in the network that may have an impact on the end user experience (e.g. events such as a network session failure, a connection failure, a network failure, etc.). This can be particularly challenging where surrogate servers are deployed, e.g. in a high-speed streaming network, such as a video content delivery network (CDN) or other networks providing similar services.

There already exist techniques for detecting events in a telecommunications network. In some of these existing techniques, artificial intelligence (AI) and machine learning (ML) is used in the detection of events, and such techniques often rely on a regular ML model or a deep recurrent neural network (RNN). However, these existing techniques can be inaccurate and inefficient.

### SUMMARY

As mentioned earlier, existing techniques that use a regular ML model or deep RNN in the detection of events in a telecommunications network can be inaccurate and inefficient. In particular, it is has been realised that it is not possible for a regular ML model to appropriately capture the characteristics of sequential behaviour in the network, while a deep RNN may be able to learn some contexts from sequential behaviours in the network but it performs poorly for longer sequences. In addition, for a deep RNN, it is generally more difficult to train a longer sequence and to apply that trained longer sequence for the fast prediction of events in real time. This can be particularly problematic when applied to realistic cases, such as high-speed streaming network operations.

The existing techniques for detecting events in a telecommunications network mainly apply traditional machine learning methods (such as regular tree-based algorithms) or deep neural network models (such as an RNN model) for sequence learning, e.g. a long-short-term-memory (LSTM) and a gated recurrent unit (GRU). However, due to the training cost associated with such methods and models, there are few engineering applicable solutions for LSTM and GRU in the real-time prediction of events in a network (i.e. in network inference).

It is an object of the disclosure to obviate or eliminate at least some of the above-described disadvantages associated with existing techniques.

Therefore, according to an aspect of the disclosure, there is provided a first computer-implemented method for processing data items for use in training a machine learning model to identify a relationship between the data items. The data items correspond to one or more features of a telecommunications network. The first method comprises, for each feature of the one or more features, organising the corresponding data items into a sequence according to time to obtain at least one sequence of data items. The first method also comprises encoding a single sequence of data items comprising the at least one sequence of data items to obtain an encoded sequence of data items. The single sequence of data items is encoded with information indicative of a position of data items in the single sequence of data items. The encoded sequence of data items is for use in training the machine learning model to identify the relationship between the data items.

According to another aspect of the disclosure, there is provided a second computer-implemented method for training a machine learning model to identify a relationship between data items corresponding to one or more features of a telecommunications network. The second method comprises training the machine learning model to identify the relationship between the data items in an encoded sequence of data items. The encoded sequence of data items is obtained by, for each feature of the one or more features, organising the corresponding data items into a sequence according to time to obtain at least one sequence of data items, and encoding a single sequence of data items comprising the at least one sequence of data items. The single sequence of data items is encoded with information indicative of a position of data items in the single sequence of data items. The relationship between the data items in the encoded sequence of data items is identified based on the information indicative of the position of data items in the single sequence of data items.

According to another aspect of the disclosure, there is provided a third computer-implemented method performed by a system. The third method comprises the first method described earlier and the second method described earlier.

According to another aspect of the disclosure, there is provided a first entity configured to operate in accordance with the first method described earlier. In some embodiments, the first entity may comprise processing circuitry configured to operate in accordance with the first method described earlier. In some embodiments, the first entity may comprise at least one memory for storing instructions which, when executed by the processing circuitry, cause the first entity to operate in accordance with the first method described earlier.

According to another aspect of the disclosure, there is provided a second entity configured to operate in accordance with the second method described earlier. In some embodiments, the second entity may comprise processing circuitry configured to operate in accordance with the second method described earlier. In some embodiments, the second entity may comprise at least one memory for storing instructions which, when executed by the processing circuitry, cause the second entity to operate in accordance with the second method described earlier.

According to another aspect of the disclosure, there is provided a system comprising the first entity described earlier and the second entity described earlier.

According to another aspect of the disclosure, there is provided a computer program comprising instructions which, when executed by processing circuitry, cause the processing circuitry to perform the first method described earlier and/or the second method described earlier.

According to another aspect of the disclosure, there is provided a computer program product, embodied on a non-transitory machine-readable medium, comprising instructions which are executable by processing circuitry to cause the processing circuitry to perform the first method described earlier and/or the second method described earlier.

Therefore, there is provided an advantageous technique for processing data items for use in training a machine learning model to identify a relationship between the data items corresponding to one or more features of a telecommunications network. There is also provided an advantageous technique for training the machine learning model to identify the relationship between the data items. The manner in which the data items are processed and the use of data items processed in this way in training a machine learning model to identify a relationship between the data items provides a trained machine learning model that can more accurately and efficiently predict the relationship between the data items in practice.

### BRIEF DESCRIPTION OF THE DRAWINGS

For a better understanding of the techniques, and to show how they may be put into effect, reference will now be made, by way of example, to the accompanying drawings, in which:

FIG. 1 is a block diagram illustrating a first entity according to an embodiment;

FIG. 2 is a flowchart illustrating a method performed by the first entity according to an embodiment;

FIG. 3 is a block diagram illustrating a second entity according to an embodiment;

FIG. 4 is a flowchart illustrating a method performed by the second entity according to an embodiment;

FIG. 5 is a schematic illustration of an example network;

FIG. 6 is a schematic illustration of a system according to an embodiment;

FIG. 7 is a schematic illustration of a system according to an embodiment;

FIGS. 8 and 9 are schematic illustrations of methods performed according to some embodiments;

FIG. 10 is a schematic illustration of a transformer according to an embodiment;

FIGS. 11 and 12 are schematic illustrations of methods performed according to some embodiments;

FIG. 13 is a schematic illustration of a machine learning model architecture according to an embodiment; and

FIG. 14 is a schematic illustration of a method performed according to an embodiment.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, there is described herein an advantageous technique for processing data items for use in training a machine learning model to identify a relationship between the data items corresponding to one or more features of a telecommunications network. This technique can be performed by a first entity. There is also described herein an advantageous technique for training the machine learning model to identify the relationship between the data items. This technique can be performed by a second entity. The first entity and the second entity described herein may communicate with each other, e.g. over a communication channel, to implement the techniques described herein. In some embodiments, the first entity and the second entity may communicate over the cloud. The techniques described herein can be implemented in the cloud according to some embodiments. The techniques described herein are computer-implemented.

The telecommunications network referred to herein can be any type of telecommunications network. For example, the telecommunications network referred to herein can be a mobile network, such as a fourth generation (4G) mobile network, a fifth generation (5G) mobile network, a sixth generation (6G) mobile network, or any other generation mobile network. In some embodiments, the telecommunications network referred to herein can be a radio access network (RAN), or any other type of telecommunications network. In some embodiments, the telecommunications network referred to herein may be a content delivery network (CDN).

The advantageous techniques described herein involve the use of artificial intelligence/machine learning (AI/ML). For example, an AI/ML engine can be embedded on a back-end of a network node (e.g. a server) in order to provide training and inference according to the techniques described herein. In general, techniques based on AI/ML allow a back-end engine to provide accurate and fast inference and feedback, e.g. in nearly real-time. In particular, the techniques described herein can beneficially enable detection of an event in a network accurately and efficiently.

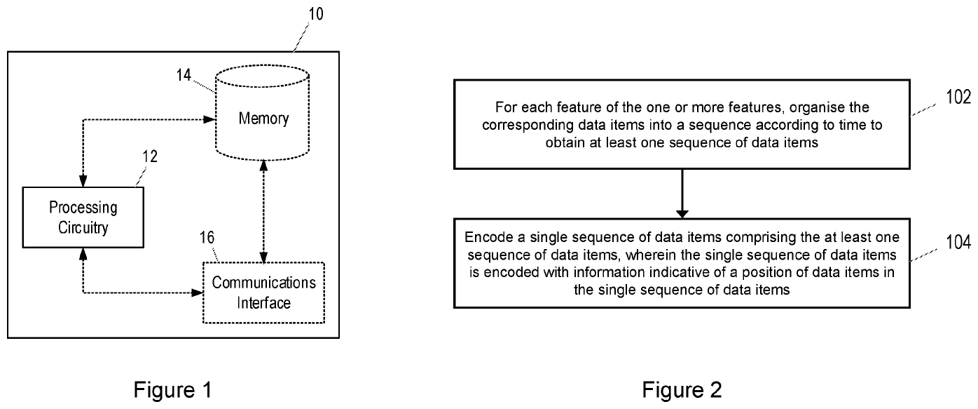

FIG. 1 illustrates a first entity 10 in accordance with an embodiment. The first entity 10 is for processing data items for use in training a machine learning model to identify a relationship between the data items. The data items correspond to one or more features of a telecommunications network. The first entity 10 referred to herein can refer to equipment capable, configured, arranged and/or operable to communicate directly or indirectly with the second entity referred to herein, and/or with other entities or equipment to enable and/or to perform the functionality described herein. The first entity 10 referred to herein may be a physical entity (e.g. a physical machine) or a virtual entity (e.g. a virtual machine, VM).

As illustrated in FIG. 1, the first entity 10 comprises processing circuitry (or logic) 12. The processing circuitry 12 controls the operation of the first entity 10 and can implement the method described herein in respect of the first entity 10. The processing circuitry 12 can be configured or programmed to control the first entity 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first entity 10. In some embodiments, the processing circuitry 12 can be configured to run software to perform the method described herein in respect of the first entity 10. The software may be containerised according to some embodiments. Thus, in some embodiments, the processing circuitry 12 may be configured to run a container to perform the method described herein in respect of the first entity 10.

Briefly, the processing circuitry 12 of the first entity 10 is configured to, for each feature of the one or more features, organise the corresponding data items into a sequence according to time to obtain at least one sequence of data items. The processing circuitry 12 of the first entity 10 is also configured to encode a single sequence of data items comprising the at least one sequence of data items to obtain an encoded sequence of data items. The single sequence of data items is encoded with information indicative of a position of data items in the single sequence of data items. The encoded sequence of data items is for use in training the machine learning model to identify the relationship between the data items.

As illustrated in FIG. 1, in some embodiments, the first entity 10 may optionally comprise a memory 14. The memory 14 of the first entity 10 can comprise a volatile memory or a non-volatile memory. In some embodiments, the memory 14 of the first entity 10 may comprise a non-transitory media. Examples of the memory 14 of the first entity 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the first entity 10 can be connected to the memory 14 of the first entity 10. In some embodiments, the memory 14 of the first entity 10 may be for storing program code or instructions which, when executed by the processing circuitry 12 of the first entity 10, cause the first entity 10 to operate in the manner described herein in respect of the first entity 10. For example, in some embodiments, the memory 14 of the first entity 10 may be configured to store program code or instructions that can be executed by the processing circuitry 12 of the first entity 10 to cause the first entity 10 to operate in accordance with the method described herein in respect of the first entity 10. Alternatively or in addition, the memory 14 of the first entity 10 can be configured to store any information, data, messages, requests, responses, indications, notifications, signals, or similar, that are described herein. The processing circuitry 12 of the first entity 10 may be configured to control the memory 14 of the first entity 10 to store information, data, messages, requests, responses, indications, notifications, signals, or similar, that are described herein.

In some embodiments, as illustrated in FIG. 1, the first entity 10 may optionally comprise a communications interface 16. The communications interface 16 of the first entity 10 can be connected to the processing circuitry 12 of the first entity 10 and/or the memory 14 of first entity 10. The communications interface 16 of the first entity 10 may be operable to allow the processing circuitry 12 of the first entity 10 to communicate with the memory 14 of the first entity 10 and/or vice versa. Similarly, the communications interface 16 of the first entity 10 may be operable to allow the processing circuitry 12 of the first entity 10 to communicate with any one or more of the other entities (e.g. the second entity) referred to herein. The communications interface 16 of the first entity 10 can be configured to transmit and/or receive information, data, messages, requests, responses, indications, notifications, signals, or similar, that are described herein. In some embodiments, the processing circuitry 12 of the first entity 10 may be configured to control the communications interface 16 of the first entity 10 to transmit and/or receive information, data, messages, requests, responses, indications, notifications, signals, or similar, that are described herein.

Although the first entity 10 is illustrated in FIG. 1 as comprising a single memory 14, it will be appreciated that the first entity 10 may comprise at least one memory (i.e. a single memory or a plurality of memories) 14 that operate in the manner described herein. Similarly, although the first entity 10 is illustrated in FIG. 1 as comprising a single communications interface 16, it will be appreciated that the first entity 10 may comprise at least one communications interface (i.e. a single communications interface or a plurality of communications interface) 16 that operate in the manner described herein. It will also be appreciated that FIG. 1 only shows the components required to illustrate an embodiment of the first entity 10 and, in practical implementations, the first entity 10 may comprise additional or alternative components to those shown.

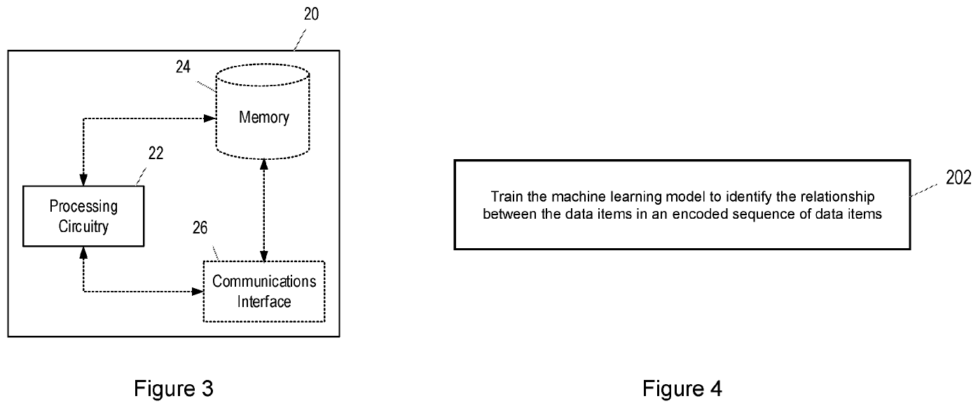

FIG. 2 illustrates a first method performed by the first entity 10 in accordance with an embodiment. The first method is computer-implemented. The first method is for processing data items for use in training a machine learning model to identify a relationship between the data items. The data items correspond to one or more features of a telecommunications network. The first entity 10 described earlier with reference to FIG. 1 can be configured to operate in accordance with the method of FIG. 2. The method can be performed by or under the control of the processing circuitry 12 of the first entity 10 according to some embodiments.

With reference to FIG. 2, as illustrated at block 102, for each feature of the one or more features, the corresponding data items are organised into a sequence according to time to obtain at least one sequence of data items. As illustrated at block 104 of FIG. 2, a single sequence of data items comprising the at least one sequence (e.g. one or more sequences or all sequences) of data items is encoded to obtain an encoded sequence of data items. The single sequence of data items is encoded with information indicative of a position of data items in the single sequence of data items. The encoded sequence of data items is for use in training the machine learning model to identify the relationship between the data items.

The single sequence of data items referred to herein effectively provides an encoded representation of the at least one sequence of data items. In an embodiment where the at least one sequence comprises a plurality of sequences, each single sequence of the plurality of sequences may be encoded and these encoded sequences can be concatenated together to obtain the encoded representation of the plurality of sequences. In some embodiments, the encoded representation referred to herein may be an encoded representation vector, e.g. for a machine learning model.

Although not illustrated in FIG. 2, in some embodiments, the first method may comprise initiating the training of the machine learning model to identify the relationship between the data items in the encoded sequence of data items. The first entity 10 (e.g. the processing circuitry 12 of the first entity 10) can be configured to initiate this training. Herein, the term “initiate” can mean, for example, cause or establish. Thus, first entity 10 (e.g. the processing circuitry 12 of the first entity 10) can be configured to itself train the machine learning model or can be configured to cause, e.g. via a communications interface 16 of the first entity 10, another entity to train the machine learning model. The relationship between the data items can be identified based on the information indicative of the position of data items in the single sequence of data items.

In some embodiments, the relationship between the data items that is referred to herein can be a similarity measure (e.g. a similarity score). The similarity measure (e.g. similarity score) can quantify the similarity between the data items (e.g. between any two data items) in the single sequence of data items. A person skilled in the art will be aware of various techniques that can be used to determine a similarity measure (e.g. similarity score). In an example, the single sequence of data items may comprise the data items in the form of sequential vectors x=[x₁, x₂, . . . xₙ]. Each data item x can represent an embedded vector with a dimension, such as a dimension of emb_dim xᵢ ∈ [symbol] ^{emb_dim}, which can be encoded from the raw data items. In some embodiments, the relationship between any two data items xᵢ and xⱼ can be calculated by an attention mechanism. For example, the relationship (“Attention”) between any two data items xᵢ and xⱼ may be calculated as follows:

Attention(xᵢ,xⱼ)=Σₖsimilarity(xᵢ,xₖ)xⱼ,

where the subscript k denotes the index of each data item in the single sequence of data items, except the data item xⱼ. The similarity in the above equation may be defined by a scaled dot-product, for example, using a softmax function (or normalized exponential function) as follows:

$$Similarity ( {x}_{i} , {x}_{k} ) = softmax ( \frac{{x}_{i}^{T} {x}_{k}}{\sqrt{d}} ) ,$$

where d is the number of units in a layer (namely, the attention layer) that performs the calculation. The scaled dot-product can ensure that the similarity measure (e.g. similarity score) will not be saturated due to a sigmoid-like calculation.

Although also not illustrated in FIG. 2, in some embodiments, the first method may comprise periodically initiating a retraining of the machine learning model to identify the relationship between the data items in the encoded sequence of data items. The first entity 10 (e.g. the processing circuitry 12 of the first entity 10) can be configured to initiate this retraining. For example, the first entity 10 (e.g. the processing circuitry 12 of the first entity 10) can be configured to itself retrain the machine learning model or can be configured to cause, e.g. via a communications interface 16 of the first entity 10, another entity to retrain the machine learning model. Herein, the term periodically can refer to a step being performed at predefined intervals in time, or in response to a predefined trigger (e.g. when a historical data set comprising data items is updated).

In some embodiments, each feature of the one or more features may have a time stamp for use in organising the corresponding data items into the sequence according to time. Thus, the data items may be organised into the sequence according to the associated time stamp according to some embodiments.

Although not illustrated in FIG. 2, in some embodiments, the method may comprise embedding the at least one sequence of data items into the single sequence of data items. The first entity 10 (e.g. the processing circuitry 12 of the first entity 10) can be configured to perform this embedding. In some embodiments, each of the at least one sequence of data items may be in the form a vector. In some embodiments, the data items may be acquired from at least one network node (e.g. server or base station) of the telecommunications network.

Although not illustrated in FIG. 2, in some embodiments, the first method may comprise initiating training of the machine learning model to predict a probability of an event occurring in the telecommunications network. The first entity 10 (e.g. the processing circuitry 12 of the first entity 10) can be configured to initiate this training. For example, the first entity 10 (e.g. the processing circuitry 12 of the first entity 10) can be configured to itself train the machine learning model to predict the probability of the event occurring in the telecommunications network or can be configured to cause, e.g. via a communications interface 16 of the first entity 10, another entity to train the machine learning model to predict the probability of the event occurring in the telecommunications network. In some embodiments, the method may comprise periodically initiating a retraining of the machine learning model to predict the probability of the event occurring in the telecommunications network. The first entity 10 (e.g. the processing circuitry 12 of the first entity 10) can be configured to initiate this retraining. For example, the first entity 10 (e.g. the processing circuitry 12 of the first entity 10) can be configured to itself retrain the machine learning model to predict the probability of the event occurring in the telecommunications network or can be configured to cause, e.g. via a communications interface 16 of the first entity 10, another entity to retrain the machine learning model to predict the probability of the event occurring in the telecommunications network.

Although also not illustrated in FIG. 2, in some embodiments, the method may comprise initiating use of the trained machine learning model to predict a probability of the event occurring in the telecommunications network. The first entity 10 (e.g. the processing circuitry 12 of the first entity 10) can be configured to initiate this use. For example, the first entity 10 (e.g. the processing circuitry 12 of the first entity 10) can be configured to itself use the trained machine learning model or can be configured to cause, e.g. via a communications interface 16 of the first entity 10, another entity to use the trained machine learning model.

In some embodiments, the method may comprise, if the predicted probability of the event occurring in the telecommunications network is above a predefined threshold, initiating an action in the telecommunications network to prevent or minimise an impact of the event. In some embodiments, the predicted probability may be a binary value, where a value of 1 can be indicative that the event will occur and a value of 0 can be indicative that the event will not occur. The predefined threshold may, for example, be set to a value of 0.5 as a fair decision boundary for such a binary classification. However, in other embodiments, another predefined threshold may be identified, e.g. a brute force search may be used to identify an appropriate (or the best) threshold. If an action is to be initiated in the telecommunications network, the first entity 10 (e.g. the processing circuitry 12 of the first entity 10) can be configured to initiate this action. For example, the first entity 10 (e.g. the processing circuitry 12 of the first entity 10) can be configured to itself implement the action or can be configured to cause, e.g. via a communications interface 16 of the first entity 10, another entity to implement the action.

In some embodiments, the action may be an adjustment to at least one network node (e.g. server or base station) of the telecommunications network. In some embodiments, the event may be any one or more of a failure of a communication session in the telecommunications network, a failure of a network node (e.g. server or base station) of the telecommunications network, an anomaly in a behaviour of the telecommunications network, and any other action to prevent or minimise an impact of the event. In some embodiments, the event may be a connection failure in the telecommunications network.

In some embodiments, the method may comprise initiating transmission of information indicative of the prediction of an event occurring in the telecommunications network. In this way, feedback can be provided. The first entity 10 (e.g. the processing circuitry 12 of the first entity 10) can be configured to initiate the transmission of this information. For example, the first entity 10 (e.g. the processing circuitry 12 of the first entity 10) can be configured to itself transmit the information or can be configured to cause, e.g. via a communications interface 16 of the first entity 10, another entity to transmit the information. The information may be utilised to make a decision on whether or not to take an action in the telecommunications network and/or what action to take in the telecommunications network, e.g. so as to prevent or minimise an impact of the event. For example, the decision can be about resource allocation in the telecommunications network (such as whether or not to adjust the allocation of resources in the telecommunications network, e.g. so as to achieve a more efficient allocation for a future incoming load to the network).

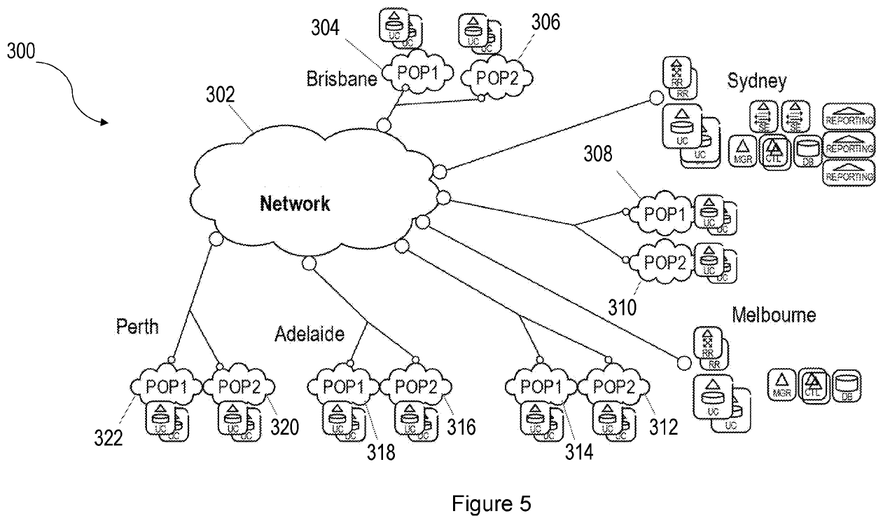

FIG. 3 illustrates a second entity 20 in accordance with an embodiment. The second entity 20 is for training a machine learning model to identify a relationship between data items corresponding to one or more features of a telecommunications network. The second entity 20 referred to herein can refer to equipment capable, configured, arranged and/or operable to communicate directly or indirectly with the first entity 10 referred to herein, and/or with other entities or equipment to enable and/or to perform the functionality described herein. The second entity 20 referred to herein may be a physical entity (e.g. a physical machine) or a virtual entity (e.g. a virtual machine, VM).

As illustrated in FIG. 3, the second entity 20 comprises processing circuitry (or logic) 22. The processing circuitry 22 controls the operation of the second entity 20 and can implement the method described herein in respect of the second entity 20. The processing circuitry 22 can be configured or programmed to control the second entity 20 in the manner described herein. The processing circuitry 22 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the second entity 20. In some embodiments, the processing circuitry 22 can be configured to run software to perform the method described herein in respect of the second entity 20. The software may be containerised according to some embodiments. Thus, in some embodiments, the processing circuitry 22 may be configured to run a container to perform the method described herein in respect of the second entity 20.

Briefly, the processing circuitry 22 of the second entity 20 is configured to train the machine learning model to identify the relationship between the data items in an encoded sequence of data items. The encoded sequence of data items is obtained by, for each feature of the one or more features, organising the corresponding data items into a sequence according to time to obtain at least one sequence of data items, and encoding a single sequence of data items comprising the at least one sequence of data items. The single sequence of data items is encoded with information indicative of a position of data items in the single sequence of data items. The relationship between the data items in the encoded sequence of data items is identified based on the information indicative of the position of data items in the single sequence of data items.

As illustrated in FIG. 3, in some embodiments, the second entity 20 may optionally comprise a memory 24. The memory 24 of the second entity 20 can comprise a volatile memory or a non-volatile memory. In some embodiments, the memory 24 of the second entity 20 may comprise a non-transitory media. Examples of the memory 24 of the second entity 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 22 of the second entity 20 can be connected to the memory 24 of the second entity 20. In some embodiments, the memory 24 of the second entity 20 may be for storing program code or instructions which, when executed by the processing circuitry 22 of the second entity 20, cause the second entity 20 to operate in the manner described herein in respect of the second entity 20. For example, in some embodiments, the memory 24 of the second entity 20 may be configured to store program code or instructions that can be executed by the processing circuitry 22 of the second entity 20 to cause the second entity 20 to operate in accordance with the method described herein in respect of the second entity 20. Alternatively or in addition, the memory 24 of the second entity 20 can be configured to store any information, data, messages, requests, responses, indications, notifications, signals, or similar, that are described herein. The processing circuitry 22 of the second entity 20 may be configured to control the memory 24 of the second entity 20 to store information, data, messages, requests, responses, indications, notifications, signals, or similar, that are described herein.

In some embodiments, as illustrated in FIG. 3, the second entity 20 may optionally comprise a communications interface 26. The communications interface 26 of the second entity 20 can be connected to the processing circuitry 22 of the second entity 20 and/or the memory 24 of second entity 20. The communications interface 26 of the second entity 20 may be operable to allow the processing circuitry 22 of the second entity 20 to communicate with the memory 24 of the second entity 20 and/or vice versa. Similarly, the communications interface 26 of the second entity 20 may be operable to allow the processing circuitry 22 of the second entity 20 to communicate with any one or more of the other entities (e.g. the first entity 10) referred to herein. The communications interface 26 of the second entity 20 can be configured to transmit and/or receive information, data, messages, requests, responses, indications, notifications, signals, or similar, that are described herein. In some embodiments, the processing circuitry 22 of the second entity 20 may be configured to control the communications interface 26 of the second entity 20 to transmit and/or receive information, data, messages, requests, responses, indications, notifications, signals, or similar, that are described herein.

Although the second entity 20 is illustrated in FIG. 3 as comprising a single memory 24, it will be appreciated that the second entity 20 may comprise at least one memory (i.e. a single memory or a plurality of memories) 24 that operate in the manner described herein. Similarly, although the second entity 20 is illustrated in FIG. 3 as comprising a single communications interface 26, it will be appreciated that the second entity 20 may comprise at least one communications interface (i.e. a single communications interface or a plurality of communications interface) 26 that operate in the manner described herein. It will also be appreciated that FIG. 3 only shows the components required to illustrate an embodiment of the second entity 20 and, in practical implementations, the second entity 20 may comprise additional or alternative components to those shown.

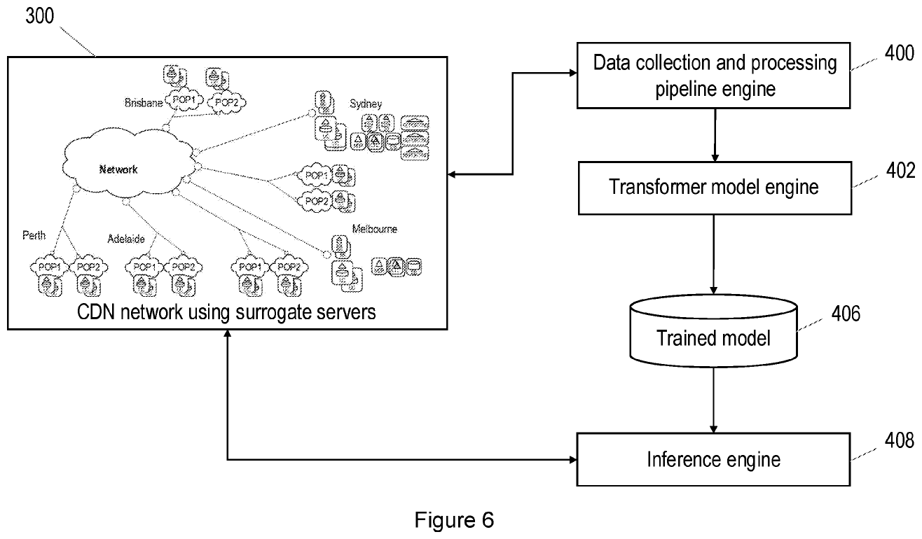

FIG. 4 illustrates a second method performed by a second entity 20 in accordance with an embodiment. The second method is computer-implemented. The second method is for training a machine learning model to identify a relationship between data items corresponding to one or more features of a telecommunications network. The second entity 20 described earlier with reference to FIG. 3 can be configured to operate in accordance with the second method of FIG. 4. The second method can be performed by or under the control of the processing circuitry 22 of the second entity 20 according to some embodiments.

With reference to FIG. 4, as illustrated at block 202, the machine learning model is trained to identify the relationship between the data items in an encoded sequence of data items. In this respect, the input to the machine learning model can be the encoded sequence of data items and the output of the machine learning model is then the identified relationship between the data items in the encoded sequence of data items. In some embodiments, the machine learning model may be further trained to predict a subsequent (e.g. next to occur) data item based on the identified relationship between the data items. The encoded sequence of data items is obtained by, for each feature of the one or more features, organising the corresponding data items into a sequence according to time to obtain at least one sequence of data items, and encoding a single sequence of data items comprising the at least one sequence of data items. The single sequence of data items is encoded with information indicative of a position of data items in the single sequence of data items. The relationship between the data items in the encoded sequence of data items is identified based on the information indicative of the position of data items in the single sequence of data items, e.g. as described earlier.

In some embodiments, each feature of the one or more features may have a time stamp. In some of these embodiments, organising the corresponding data items into the sequence according to time may comprise organising the corresponding data items into the sequence according to time using the time stamp of each feature of the one or more features. In some embodiments, the at least one sequence of data items may be embedded into the single sequence of data items. In some embodiments, the data items may be from (i.e. may originate from) at least one network node of the telecommunications network.

Although not illustrated in FIG. 4, the method may comprise periodically retraining the machine learning model to identify the relationship between the data items in the encoded sequence of data items. The second entity 20 (e.g. the processing circuitry 22 of the second entity 20) can be configured to retrain the machine learning model in this way.

Although also not illustrated in FIG. 4, the method may comprise training the machine learning model to predict a probability of an event occurring in the telecommunications network. The second entity 20 (e.g. the processing circuitry 22 of the second entity 20) can be configured to train the machine learning model to predict the probability of an event occurring in the telecommunications network. In this respect, the input to the machine learning model can be the encoded sequence of data items (e.g. in the form of sequential vectors), which can also be the input of subsequent computations (e.g. in a transformer layer). The output of the machine learning model is the probability of the event occurring (e.g. a session failing) in the telecommunications network, given a new input sequence of data items (e.g. in the form of sequential vectors). More specifically, the machine learning model can be trained using the encoded sequence of data items in the form of embedded vectors x=[x₁, x₂, . . . xₙ]. After training the machine learning model, the output probability y for a new input z can be applied to the trained machine learning model, such that y=model(z). As mentioned earlier, the output probability y can be a binary classification, i.e. 0<y<1, according to some embodiments.

Although also not illustrated in FIG. 4, the method may comprise periodically retraining the machine learning model to predict the probability of the event occurring in the telecommunications network. The second entity 20 (e.g. the processing circuitry 22 of the second entity 20) can be configured to periodically retrain the machine learning model to predict the probability of the event occurring in the telecommunications network.

Although also not illustrated in FIG. 4, the method may comprise initiating use of the trained machine learning model to predict a probability of the event occurring in the telecommunications network. The second entity 20 (e.g. the processing circuitry 22 of the second entity 20) can be configured to initiate this use. For example, the second entity 20 (e.g. the processing circuitry 22 of the second entity 20) can be configured to itself use the trained machine learning model or can be configured to cause, e.g. via a communications interface 26 of the second entity 20, another entity to use the trained machine learning model.

In some embodiments, the method may comprise, if the predicted probability of the event occurring in the telecommunications network is above a predefined threshold, initiating an action in the telecommunications network to prevent or minimise an impact of the event. The second entity 20 (e.g. the processing circuitry 22 of the second entity 20) can be configured to initiate this action. For example, the second entity 20 (e.g. the processing circuitry 22 of the second entity 20) can be configured to itself implement the action or can be configured to cause, e.g. via a communications interface 26 of the second entity 20, another entity to implement the action. In some embodiments, the action may be an adjustment to at least one network node (e.g. server or base station) of the telecommunications network. In some embodiments, the event may be any one or more of a failure of a communication session in the telecommunications network, a failure of a network node (e.g. server or base station) of the telecommunications network, an anomaly in a behaviour of the telecommunications network, and any other action to prevent or minimise an impact of the event.

In some embodiments, the information referred to herein that is indicative of the position of data items in the single sequence of data items may comprise information indicative of a position of at least one of the data items in the single sequence of data items relative to at least one other data item in the single sequence of data items and/or information indicative of a relative distance between at least two of the data items in the single sequence of data items. In some embodiments, the information referred to herein that is indicative of the position of data items in the single sequence of data items may be obtained by applying an exponential decay function to the single sequence of data items. In some of these embodiments, applying the exponential decay function to the single sequence of data items may comprise inputting values into the exponential decay function. The values can be indicative of the position of at least two of the data items in the single sequence of data items. In some embodiments, each of the at least one sequence of data items referred to herein may be in the form a vector.

In some embodiments, the one or more features of the telecommunications network referred to herein may comprise one or more features of at least one network node (e.g. server or base station) of the telecommunications network. In some of these embodiments, the at least one network node may comprise at least one network node that is configured to replicate one or more resources of at least one other network node. For example, the at least one network node may be a surrogate server of a content delivery network (CDN). Generally, a CDN may comprise one or more surrogate servers that replicate content from a central (or an origin) server. The surrogate servers can be placed in strategic locations to enable an efficient delivery of content to users of the CDN. In some embodiments, the one or more features of the telecommunications network referred to herein may comprise one or more features of a session a user (or user equipment, UE) has with the telecommunications network. Examples of the one or more features include, but are not limited to, an internet protocol (IP) address, a server identifier (ID), an account offering gate, a hypertext transfer protocol (HTTP) request, an indication of session failure, and/or any other feature of the telecommunications network.

In some embodiments, the data items referred to herein may correspond to a UE served by the telecommunications network. In some of these embodiments, an identifier that identifies the UE (or a location of the UE) may be assigned to the at least one sequence of data items. For example, the identifier may comprise information indicative of a geolocation of the UE. Alternatively or in addition, the identifier may be an IP address associated with the UE. In some embodiments, the data items referred to herein may comprise information indicative of a quality of a connection between a UE and the telecommunications network. In some of these embodiments, the connection between the UE and the telecommunications network can be a connection between the UE and at least one network node (e.g. server or base station) of the telecommunications network.

In some embodiments, the machine learning model referred to herein may be trained to identify the relationship between the data items in the encoded sequence of data items using a multi-head attention mechanism. In some embodiments, the machine learning model referred to herein may be a machine learning model that is suitable for natural language processing, and/or the machine learning model referred to herein may be a deep learning model. In some embodiments, this deep learning model may be a transformer (or a transformer model).

There is also provided a system comprising the first entity 10 described herein and the second entity 20 described herein. A computer-implemented method performed by the system comprises the method described herein in respect of the first entity 10 and the method described herein in respect of the second entity 20.

As mentioned earlier, the telecommunications network in respect of which the techniques described herein can be implemented may be any type of telecommunications network and one example is a content delivery network (CDN).

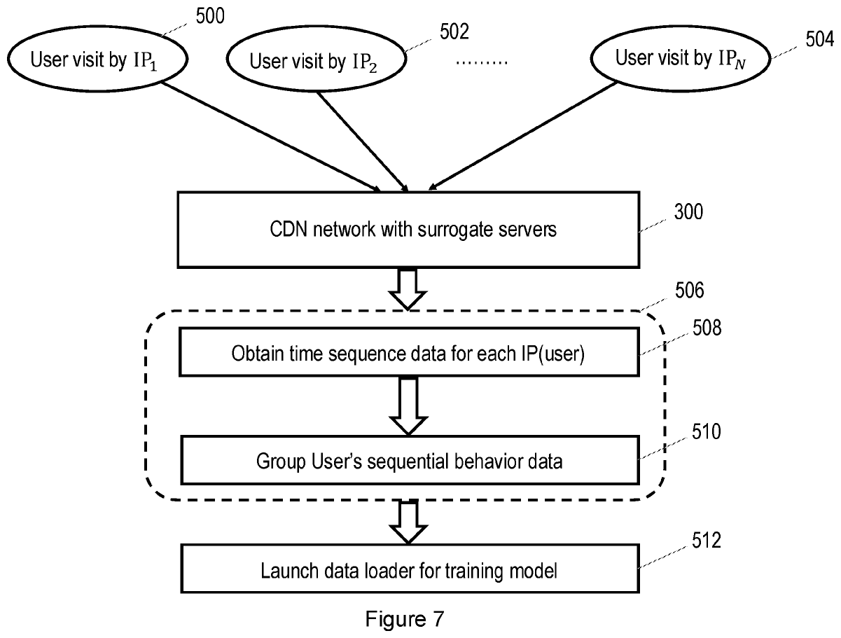

FIG. 5 illustrates an example of such a CDN 300. The CDN comprises a central (or origin) network 302 (e.g. comprising one or more servers) and a plurality of (local) surrogate servers 304, 306, 308, 310, 312, 314, 316, 318, 320, 322.

Generally, the CDN can be configured to allocate the surrogate servers 304, 306, 308, 310, 312, 314, 316, 318, 320, 322 according to visit sessions from different Internet Protocol (IP) addresses, e.g. corresponding to different users of the CDN 300. The surrogate servers 304, 306, 308, 310, 312, 314, 316, 318, 320, 322 can replicate (network) content from a server of the central network 302. The surrogate servers 304, 306, 308, 310, 312, 314, 316, 318, 320, 322 can be placed in strategic locations to enable a more efficient delivery of content to users. With the increased amount of content (e.g. video traffic) in recent years, it is valuable for the CDN 300 to be able to cope with high demand and speed in order to provide satisfactory user experiences. In this context, it can be beneficial to (track and) analyse data items corresponding to one or more features of the CDN 300 (such as data items comprising information indicative of a quality of a connection between a UE and the CDN 300), e.g. in order to provide better network services.

Feedback from visiting sessions of users (e.g. from collected traces) can be related to key performance indicators (KPI), which may be provided by data from back-end event records (e.g. log files). Such feedback may allow the CDN 300 to evaluate a quality of service (QOS) offered to users of the CDN 300 and this evaluation may be used to influence a Quality of Experience (QoE) for the users. For example, KPIs can comprise a download bit rate (DBR), which is indicative of a rate at which data may be transferred from a surrogate server to a user, a content (e.g. video) quality level (QL), and/or any other KPI, or any combination of KPIs. KPI features can be formulated in a time-series sequence for serial sessions, some of which may fail during the connection. These failure events and other events in the network may be rare but it is beneficial to be able to (e.g. accurately and efficiently) detect events. For example, this can provide valuable information to better configure and/or operate the CDN 300, e.g. for a better reallocation of resources in the CDN 300.

Although a CDN has been described by way of an example of a telecommunications network, it will be understood that the description in respect of the CDN can also apply to any other type of telecommunications network.

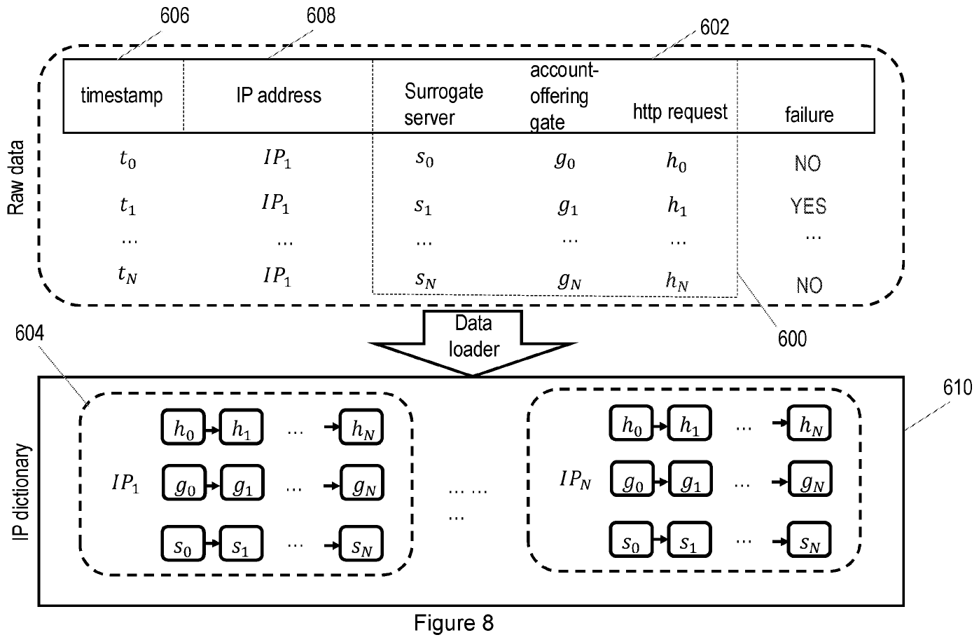

FIG. 6 illustrates a system according to an embodiment. In FIG. 6, the system comprises a CDN 300, which can be as described earlier with reference to FIG. 5. However, it will be understood that the system of FIG. 6 can be used with any other telecommunications network and the CDN 300 is merely used as an example. Thus, any reference to the CDN 300 herein can be replaced with a more general reference to a telecommunications network. The system illustrated in FIG. 6 comprises a data collection and processing pipeline engine 400, a transformer model engine 402, a trained model 406, and an inference engine 408. Although the data collection and processing pipeline engine 400, the transformer model engine 402, the trained model 406, and the inference engine 408 are separate modules in the embodiment illustrated in FIG. 6, it will be understood that any two or more (or all) of these modules can be comprised in the same entity according to other embodiments. Although the CDN 300 is separate to the data collection and processing pipeline engine 400, the transformer model engine 402, the trained model 406, and the inference engine 408 in the embodiment illustrated in FIG. 6, it will be understood that the CDN 300 may comprise any one or more of the data collection and processing pipeline engine 400, the transformer model engine 402, the trained model 406, and the inference engine 408 according to other embodiments.

Although not illustrated in FIG. 6, in some embodiments, the first entity 10 (or the processing circuitry 12 of the first entity 10) described herein and/or the second entity 20 (or the processing circuitry 22 of the second entity 20) described herein may comprise one or more of the data collection and processing pipeline engine 400, the transformer model engine 402, the trained model 406, and the inference engine 408. Thus, the steps described with reference to any one or more of these modules 400, 402, 406, 408 can also be said to be performed by the first entity 10 (e.g. the processing circuitry 12 of the first entity 10) and/or the second entity 20 (or the processing circuitry 22 of the second entity 20).

For example, in some embodiments, the first entity 10 (or the processing circuitry 12 of the first entity 10) described herein may comprise the data collection and processing pipeline engine 400, and the transformer model engine 402, whereas the second entity 20 (or the processing circuitry 22 of the second entity 20) described herein may comprise the trained model 406 and optionally also the inference engine 408. In some embodiments, for example, the data collection and processing pipeline engine 400 can be configured to perform the organising of data items as described herein (e.g. with reference to step 102 of FIG. 2), the transformer model engine 402 can be configured to perform the encoding of the single sequence of data items as described herein (e.g. with reference to step 104 of FIG. 2), the trained model 406 can be the model that results from the training of the machine learning model as described earlier (e.g. with reference to step 202 of FIG. 4), and the inference engine 408 can be configured to perform the use of the trained machine learning model to predict a probability of an event occurring in the telecommunications network as described earlier.

The system illustrated in FIG. 6 can be used in many situations. For example, the system illustrated in FIG. 6 can be used to perform efficient network quality detection and/or reallocation of surrogate servers in the CDN 300. In this respect, the data collection and processing pipeline engine 400 can connect data from the CDN 300 with multiple surrogate servers allocated by a central server, e.g. according to the geolocations of visitors of the CDN 300. Each visitor may be assigned an IP address with multiple operations, such as video viewing and searching during a certain time period. The data collection and processing pipeline engine 400 organises (e.g. groups) data items, such as for each visitor's session. The inference engine 408 can then predict (or recognise) a probability of an event occurring in the CDN 300, such as a connection failure. Thus, the output of the inference engine 408 can be the prediction of the probability of an event occurring in the CDN 300.

As illustrated in FIG. 6, the output of the inference engine 408 can be fed back to the CDN 300. For example, the inference engine 408 may send feedback to the CDN 300 based on the prediction. This feedback can be used to decide whether or not any action needs to be taken in the CDN 300, e.g. whether or not an adjustment needs to be made to the surrogate servers for better allocations for an incoming load. For example, the feedback may allow the CDN 300 to improve its performance, such as by better allocating resources among the surrogate servers of the CDN 300.

An issue that can exist for efficient CDN services is that the central network 302 may need to allocate appropriate surrogate servers 304, 306, 308, 310, 312, 314, 316, 318, 320, 322 in terms of their maximal loads and characteristics of each user equipment (UE) of the CDN 300. The same may be true of other telecommunications networks in terms of allocating an appropriate network node (e.g. server or base station) to a UE. A UE may be identified by an identifier, such as an internet protocol (IP) address. Each UE visit (e.g. from a particular IP address) can comprise one or more interactive sessions. For example, the one or more interactive sessions may comprise image viewing, texting, web browsing, and/or any other interactive session, or combination thereof. The interactive sessions can be associated with a time series. The session quality may be (e.g. largely) affected by one or more features of the CDN 300, such as a surrogate server identifier (ID) and/or a current content (e.g. video, text, and/or other content), which occupies network bandwidth. The interactive session may fail due to the connection quality or disproportionate load balancing between the surrogate servers of the CDN 300. Therefore, predicting a probability of an event occurring that can have an impact on a session (e.g. that can cause a failure of a session) can be a useful indicator of network quality.

The probability of such an event occurring can be relatively low compared with most successful sessions, making it difficult to accurately predict the event in time for action to be taken to avoid it (e.g. in real-time). However, using the advantageous techniques described herein, it is possible to embed a machine learning model (e.g. a deep learning model) into a system that can accurately and efficiently predict the event. For example, the machine learning model may be trained using (e.g. large volumes of) network session data (e.g. historical logged session data) to perform inference. The system described herein uses a cutting-edge methodology, which can be applied to, among others, the telecommunication domain. The core engine for the machine learning model training described herein, according to some embodiments, may advantageously be based on a deep transformer network model, as originally proposed to solve language translation tasks.

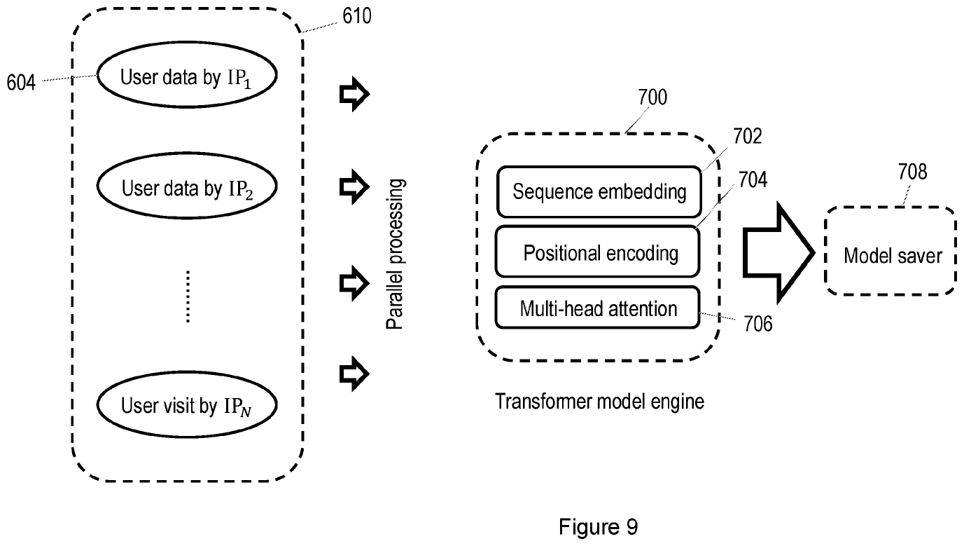

FIG. 7 illustrates a system according to an embodiment. In FIG. 7, the system comprises a CDN 300, which can be as described earlier with reference to FIG. 5. However, it will be understood that the system of FIG. 7 can be used with any other telecommunications network and the CDN 300 is merely used as an example. Thus, any reference to the CDN 300 herein can be replaced with a more general reference to a telecommunications network. As illustrated in FIG. 7, the CDN 300 can be visited by one or more users 500, 502, 504. In some embodiments, each user 500, 502, 504 of the CDN 300 may be identified by an identifier, such as an IP address (e.g. IP₁, IP₂, . . . , IP_{N}).

The system illustrated in FIG. 7 comprises a data collection and pre-processing engine 506. The data collection and pre-processing engine 506 may also be referred to herein as a data loader. Although not illustrated in FIG. 7, in some embodiments, the first entity 10 (or the processing circuitry 12 of the first entity 10) described herein may comprise the data collection and pre-processing engine 506. Thus, the steps described with reference to the data collection and pre-processing engine 506 can also be said to be performed by the first entity 10 (e.g. the processing circuitry 12 of the first entity 10). In some embodiments, the data collection and pre-processing engine 506 can be configured to perform the organising of data items as described herein (e.g. with reference to step 102 of FIG. 2).

In more detail, in some embodiments, as illustrated at block 508 of FIG. 7, the data collection and pre-processing engine 506 can be configured to obtain a time sequence of data items for each user of the CDN 300. The data items for each user of the CDN 300 correspond to one or more features of the CDN 300, such as a behaviour of the user of the CDN 300. In some embodiments, as illustrated at block 510 of FIG. 7, the data collection and pre-processing engine 506 can be configured to implement a parallel processing technique and organise (e.g. group) the data items in a novel way such that the machine learning model described herein can understand time-sequential features (e.g. for each user of the CDN 300). As illustrated at block 512 of FIG. 7, the data collection and pre-processing engine 506 may be launched for training the machine learning model in the manner described herein. In order to apply the machine learning model (e.g. a deep transformer model), it may be beneficial to create multiple input sequences of data items for each feature of each network session.

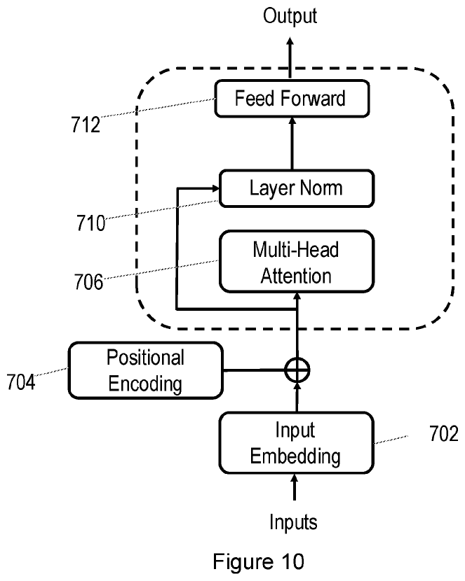

FIG. 8 illustrates an example method for processing data items corresponding to one or more features of a telecommunications network according to an embodiment. More specifically, FIG. 8 illustrates an example of how the data items can be organised into a sequence by the first entity 10 (e.g. the processing circuitry 12, such as the data collection and processing pipeline engine 400 or the data collection and pre-processing engine 506, of the first entity 10) described herein.

As illustrated in FIG. 8, the input data (e.g. raw data) can comprise data items 600 which correspond to one or more features 602 of a telecommunications network (e.g. the CDN 300 described earlier or any other telecommunications network). For example, the corresponding features 602 can comprise a surrogate server identifier (ID), a download bit rate (DBR), an account-offering gate, a hypertext transfer protocol (HTTP) link, or any other features of the telecommunication network, or any combination of such features. The data items 600 can correspond to a user (or a UE) served by the telecommunications network. As illustrated in FIG. 8, the input data may comprise an identifier (e.g. an IP address) 608 that identifies the user (or a location of the user) to which the data items 600 correspond. Each feature of the one or more features 602 can have a time stamp 606. As illustrated in FIG. 8, the input data may comprise this time stamp 606. The time stamp 606 can be used to organise the corresponding data items 600.

For each feature of the one or more features 602, the first entity 10 (e.g. the processing circuitry 12, such as the data collection and processing pipeline engine 400 or the data collection and pre-processing engine 506, of the first entity 10) described herein, can organise (e.g. all of) the corresponding data items 600 into a sequence according to time to obtain at least one sequence of data items 604. As illustrated in FIG. 8, the at least one sequence of data items 604 may be organised in a dictionary format 610. In some embodiments, the dictionary format 610 may use the identifier (e.g. IP address) 608 of the user as a key and the corresponding at least one sequence of data items 604 (which may be in the form of at least one sequential vector) as a value. The identifier 608 that identifies the user can be assigned to the at least one sequence of data items in this way. As illustrated in FIG. 8, the data items 600 are sorted into at least one sequence 604 according to time. Each input feature 602 may have a corresponding vector of sequential data items.

It may be assumed that the probability of an event occurring in the telecommunications network (e.g. a network failure) at a time T will be affected by sequenced data items from times T−1, T−2, . . . . T-n (where n may be a maximum number of data items in a sequence that the machine learning model will accept as input). The processing of the data items described herein can be easily and efficiently be adapted with parallel processing, particularly since the at least one sequence of data items referred to herein (e.g. in a dictionary format) can easily and efficiently be retrieved during an inference (or prediction) phase, e.g. by using the identifier (IP address) that identifies the user concerned.

FIG. 9 illustrates a method for processing data items corresponding to one or more features of a telecommunications network and training a machine learning model to identify a relationship between the data items according to an embodiment. As illustrated in FIG. 9, the at least one sequence of data items 604 (e.g. organised in a dictionary format 610) is input into a transformer model engine 700, such as by the earlier-described data collection and pre-processing engine (or data loader) 506, which is not illustrated in FIG. 9.

The first entity 10 (e.g. the processing circuitry 12 of the first entity 10) described herein can comprise at least part of the transformer model engine 700 and/or the second entity 20 (e.g. the processing circuitry 22 of the second entity 20) described herein can comprise at least part of the transformer model engine 700. Thus, at least some steps (e.g. sequence embedding 702 and positional encoding 704) described with reference to the transformer model engine 700 can also be said to be performed by the first entity 10 (e.g. the processing circuitry 12 of the first entity 10) and/or at least some steps (e.g. training 706) described with reference to the transformer model engine 700 can also be said to be performed by the second entity 20 (e.g. the processing circuitry 22 of the second entity 20). As illustrated in FIG. 9, in some embodiments, a plurality of sequences of data items 604 (e.g. corresponding to different users or UEs) may be processed in parallel.

As illustrated at block 702 of FIG. 9, in some embodiments, the transformer model engine 700 may embed the at least one sequence of data items 604 into a single sequence of data items. This embedding can be referred to as sequence embedding. As illustrated at block 704 of FIG. 9, in some embodiments, the transformer model engine 700 may encode the single sequence of data items (comprising the at least one sequence of data items 604) to obtain an encoded sequence of data items. The single sequence of data items is encoded with information indicative of a position of data items in the single sequence of data items. Thus, the encoding can be referred to as positional encoding.

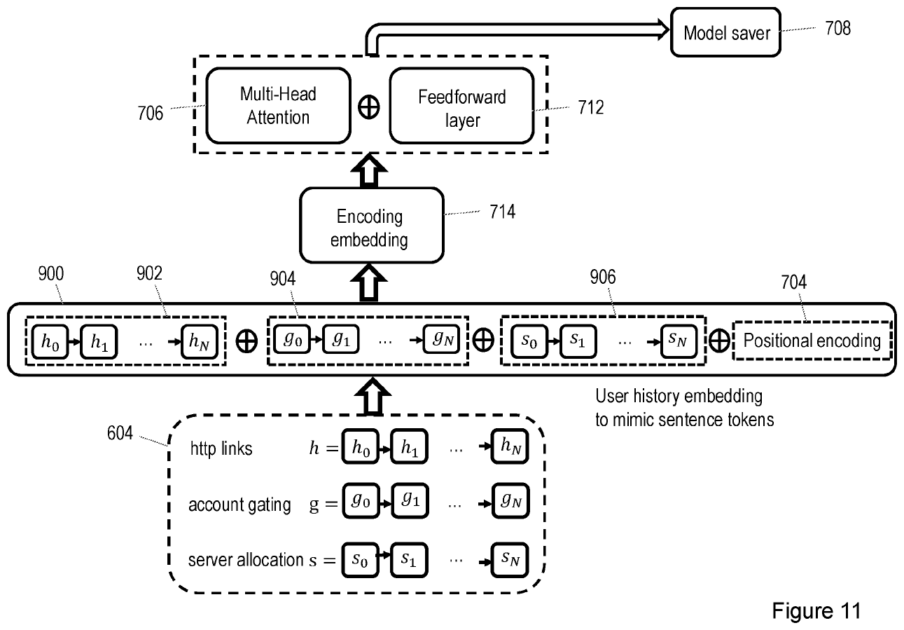

As illustrated at block 706 of FIG. 9, the transformer model engine 700 may train the machine learning model to identify the relationship between the data items in the encoded sequence of data items. For example, the machine learning model may be trained to identify the relationship between the data items in the encoded sequence of data items using a multi-head attention mechanism. In this way, it is possible for the transformer model engine 700 to learn the relationship between multiple data items, such as those provided by a back-end server. In some embodiments, the transformer model engine 700 may comprise an encoder and a decoder. In these embodiments, both the encoder and the decoder may perform sequence embedding 702, positional encoding 704, and training 706. This embodiment will be described in more detail later with reference to FIG. 10.

As illustrated in FIG. 9, in some embodiments, the transformer model engine 700 may be configured to save its output at a model saver module 708, e.g. the memory 22 of the second entity 20 or any other memory.

FIG. 10 illustrates a general structure for a transformer with multi-headed attention according to an embodiment. As illustrated in FIG. 10, the input (e.g. input data) is the at least one sequence of data items.

At block 702 of FIG. 10, the at least one sequence of data items may be embedded into a single sequence of data items. For example, the at least one sequence of data items can be embedded in an embedding layer. At block 704 of FIG. 10, the single sequence of data items (comprising the at least one sequence of data items 604) is encoded to obtain an encoded sequence of data items. The single sequence of data items is encoded with information indicative of a position of data items in the single sequence of data items. For example, the relative position of each data item may be encoded by a positional encoding layer. At block 706 of FIG. 10, the machine learning model is trained to identify the relationship between the data items in the encoded sequence of data items, e.g. using a multi-head attention mechanism. The multi-head attention mechanism can thus be applied to learn a relationship (e.g. a sentimental relationship) between data items in the encoded sequence. The relationship between data items across the entire encoded sequence may be identified.

At block 710 of FIG. 10, a layer normalisation is applied. This can, for example, ensure that the output does not drift due to any variation in the data item distribution. At block 712 of FIG. 10, a regular feedforward layer can be applied.

The technique described herein can outperform existing techniques (e.g. recurrent neural network (RNN) techniques) as the technique described herein can not only learn the relationship between two data items that are close in their position in the sequence of data items, but also the relationship of two data items having a similar meaning even if those data items are physically far away from each other in their position in the sequence of data items.

In some embodiments, the overall output of the transformer structure illustrated in FIG. 10 may be the probability of a data item occurring as a result of the given input sequence(s). For example, Prob(y|w₁, w₂, . . . wₙ) may represent the most probable data item y following an input sequence comprising the data items w₁, w₂, . . . wₙ.

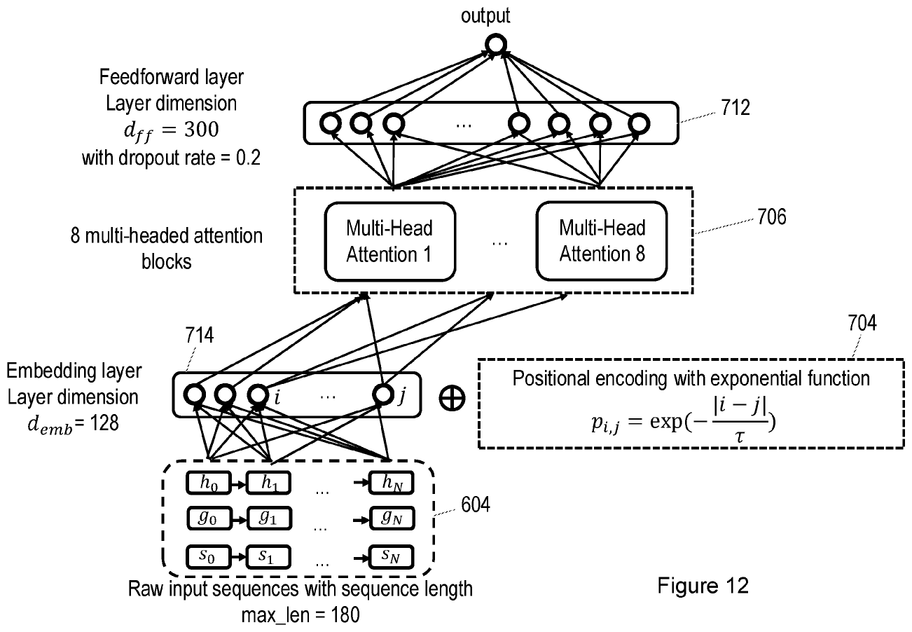

FIG. 11 illustrates a method for processing data items corresponding to one or more features of a telecommunications network and training a machine learning model to identify a relationship between the data items according to an embodiment. The method can be performed by a model engine, which can be based on a transformer (i.e. a transformer model engine 700 such as that described earlier). As illustrated in FIG. 11, for each feature of the one or more features, the data items are organised into a sequence according to time to obtain at least one sequence of data items 604. The at least one sequence of data items are processed as a single sequence of data items. In some embodiments, to mimic the tokenisation procedure for sentences in natural language processing system, all data items may be binarized as categorical values before being added as a single sequence of data items. The at least one sequence (e.g. all sequences) of data items 902, 904, 906 can be in the form of sequential vectors in the single sequence 900 of data items.

The single sequence of data items 900 comprising the at least one sequence (e.g. all sequences) of data items 902, 904, 906 is encoded using positional encoding 704 to obtain an encoded sequence of data items. More specifically, the single sequence of data items 900 comprising the at least one sequence (e.g. all sequences) of data items 902, 904, 906 is encoded with information indicative of a position of data items in the single sequence of data items 900. The function of positional encoding can be to enable the machine learning model to learn the relative positions of each data item in the single sequence of data items, e.g. irrespective of the length of that single sequence of data items. Thus, the technique can be used on any length sequence of data items, even a long sequence of data items. In some embodiments, a (e.g. mathematical) function, such as an exponential decay function, can be used for the positional encoding as described earlier.

In some embodiments, the implementation may take into consideration (e.g. all) sequential behaviours of one or more historical sessions in the telecommunications network and realise the functionality of data items and sequence embedding. In some embodiments, as illustrated at block 714 of FIG. 11, the positional encoding 704 may be embedded into the single sequence of data items.

In some embodiments, after encoding 704 and optionally also embedding 714, the encoded sequence of data items 900 may be input into a multi-head attention block 706 (e.g. an 8-layered multi-head attention block), which may be a part of the model engine according to some embodiments. As illustrated in FIG. 11, the model engine may also comprise a feedforward layer 712. The machine learning model may be trained to identify the relationship between the data items in the encoded sequence of data items 900 using a multi-head attention and feedforward mechanism.

The use of a multi-head attention mechanism can ensure that any bias, e.g. from random seeding in the system, is reduced. Typically, multiple calculations based on a single attention head can be performed with different random seeds, which generate different initial embedding vectors x. For example, multiple outputs can be obtained for different attention matrices, e.g. attention₁, attention₂, . . . attention_{N} may be obtained based on different random seeds. The random seeds can, for example, be set by a user (e.g. modeller). Following the multiple calculations performed with different random seeds, a multi-head attention vector may be obtained by concatenating the outputs of these calculations, e.g. as follows:

MultiHeadedAtten=[attention₁,attention₂, . . . attention_{N}].

After the operation for multi-headed attention is complete, a regular feedforward layer can be applied on the above multi-headed attention vector. In some embodiments, the trained machine learning model may be stored in memory (e.g. the model saver 708), which may be a memory of the second entity 20 described herein or another memory.

FIG. 12 illustrates an example of a method for processing data items corresponding to one or more features of a telecommunications network and training a machine learning model to identify a relationship between the data items according to an embodiment. In particular, FIG. 12 illustrates the embedding, positional encoding, and training steps of FIG. 11 in more detail. As described in respect of FIG. 11, for each feature of the one or more features, the data items are organised into a sequence according to time to obtain at least one sequence of data items 604.

As illustrated in FIG. 12, following the re-organisation of the input as sequential data, an embedding layer 714 is learnt. The embedding layer 714 can, for example, have 128 units. Generally, an embedding layer 714 can be used to extract a higher level embedded vector for raw input vectors. With reference to FIG. 12, the at least one sequence of data items 604 can each be in the form of an input vector and the embedding layer 714 can be used to extract a higher level embedded vector for the at least one sequence of data items 604. The at least one sequence of data items are thus processed as a single sequence of data items.

The single sequence of data items comprising the at least one sequence (e.g. all sequences) of data items is encoded using positional encoding 704 to obtain an encoded sequence of data items. More specifically, the single sequence of data items comprising the at least one sequence (e.g. all sequences) of data items is encoded with information indicative of a position of data items in the single sequence of data items. In some embodiments, a (e.g. mathematical) function, such as an exponential decay function, can be used for the positional encoding as described earlier. An example of an exponential decay function is illustrated in FIG. 12, where i denotes the position of a first data item in the single sequence of data items, j denotes the position of a second data item in the single sequence of data items, τ denotes a constant, and p_{i,j} denotes the relative distance between the first data item and the second data item in the single sequence of data items.

At block 706 of FIG. 12, the machine learning model is trained to identify the relationship between the data items in the encoded sequence of data items, e.g. using a multi-head attention mechanism. In the embodiment illustrated in FIG. 12, a transformer layer comprising 8 multi-head attention blocks is used but it will be understood that any other number of multi-head attention blocks may be used according to other embodiments. As an example of training the machine learning model to identify the relationship between the data items, the machine learning model may be trained to learn the relationship between sequential behaviours of a user (e.g. dynamically).

At block 712 of FIG. 12, a feedforward layer is employed. The feedforward layer can, for example, comprise 300 units and/or may have a dropout rate of 0.2. The final output may be a probability of an event (e.g. failure of a current session) occurring in the telecommunications network based on previous input sequences.

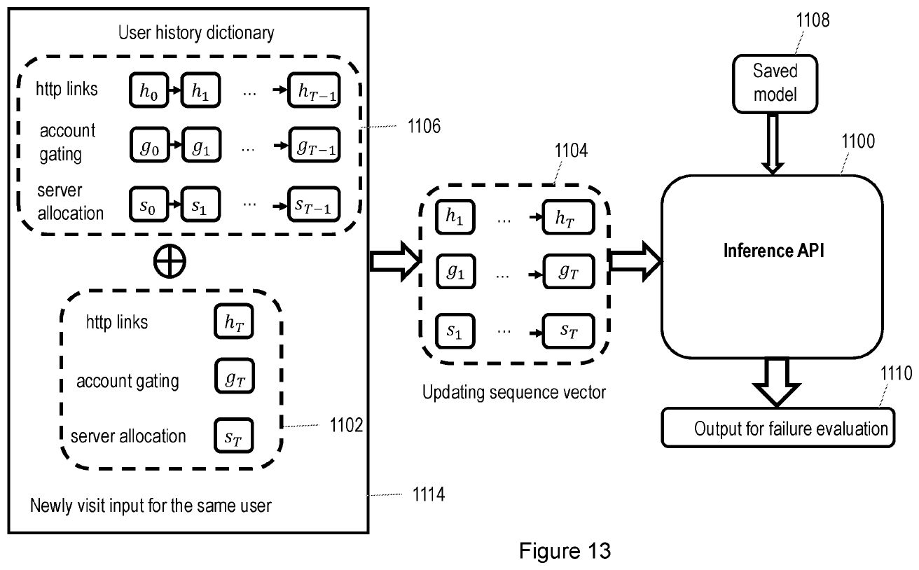

FIG. 13 illustrates an example of a machine learning model architecture according to an embodiment. The machine learning model architecture can be referred to as an inference (or prediction) engine. The second entity 20 (e.g. the processing circuitry 22 of the second entity 20) described herein can comprise the inference engine illustrated in FIG. 13. Thus, at least some steps described with reference to the inference engine illustrated in FIG. 13 can also be said to be performed by the second entity 20 (e.g. the processing circuitry 22 of the second entity 20).

As illustrated in FIG. 13, the inference engine comprises an inference application programming interface (API) 1100. The API 1100 may be used for (e.g. session) inference for predicting a probability of an event occurring in a telecommunications network (e.g. a network failure). The inference may be performed in real-time. When new incoming data items (e.g. comprising visit session data) 1102 are provided by the telecommunications network (e.g. a network node, such as a server or base station of the telecommunication network), the API 1100 may organise the input data items 1102 into corresponding groups.

As illustrated in FIG. 13, the data items 1102 correspond to one or more features of the telecommunications network (e.g. HTTP links, account gating, server allocation, and/or any other feature of the telecommunications network). The data items 1102 may be organised into corresponding groups by, for each feature of the one or more features, organising the corresponding data items into a sequence of data items according to time to obtain at least one sequence of data items 1104. The number of sequences of data items can thus correspond to the number of features. An identifier (e.g. an IP address) may be assigned to the data items 1102. The identifier may identify a UE or user to which the data items correspond.

The input data items 1102 may be formulated into updated sequences 1104 taking into account the input data items 1102 and optionally also historical (e.g. previously stored) data items 1106. For example, for each sequence of data items, the sequence may be recursively transferred from x₀, x₁, . . . x_{(T-1)} to x₁, x₂, . . . x_{T} to ensure the length of the sequence of data items is the same as for the model input. Afterwards, the previously trained machine learning (e.g. transformer) model may be called from a memory (e.g. a model saver 1108) to predict an output (e.g. to predict a probability of an event occurring in the telecommunications network, such as a session failure) 1110.

An inference test simulator, which can mimic a real-world network operation, has been developed. The following table illustrates a summary of the prediction performance and inference time for two existing machine learning models (namely, a light gradient boosting machine model and a recurrent neural network model) and a transformer model, which is an example of a machine learning model that can be used according to some embodiments described herein. The machine learning models were tested using a test data set.

| | | | Area | | |
|---|---|---|---|---|---|
| | Offline | | under | Inference | Inference |
| | Training | | curve | time per | time by |
| | time | Accuracy | (AUC) | sample | parallel |
| Model | (minutes) | (%) | score | (second) | (second) |
| Light | 100 | 89 | 0.89 | 0.066 | N/A |
| gradient | | | | | |
| boosting | | | | | |
| machine | | | | | |
| (lightGBM) | | | | | |
| Recurrent | 150 | 91 | 0.90 | 0.093 | N/A |
| neural | | | | | |
| network | | | | | |
| (RNN) | | | | | |
| Transformer | 30 | 97 | 0.96 | 0.012 | 0.003 |

By way of the above table, the performance of the two existing machine learning models can be compared with the transformer machine learning model referred to herein. The main aspects considered during testing, were off-line training performance, online inference accuracy, and response time. In order to evaluate the different existing machine learning models against the transformer model referred to herein, the testing included training using a training data set comprising 4 million samples and testing on a test data set comprising 500 K samples. The lightGBM model that was tested is an example of a traditional tree-based machine learning model, and the RNN model that was tested is an example of a long-short term memory (LSTM) model. To mimic a real-time scenario, during the inference phase of testing, batch streaming data (with 64 samples in one batch from different IP addresses) was used as input to the previously trained machine learning models.

The overall performance is shown in the above table. As illustrated in the above table, it can be concluded that the transformer model, which can be used according to some embodiments described herein, takes much less time during the offline training phase. This is advantageous as it ensures that the previously trained machine learning model (e.g. on a back-end of a network server) can be updated frequently when a historical data set is updated. During online testing/inference, the transformer model was able to achieve 97% accuracy (which was measured as the number of correct predictions per number of samples). An area under curve (AUC) score was also evaluated by considering precision and recall for binary classes. In general, the AUC score is considered to be a more fair evaluation metric for imbalanced data such as rare failure or anomaly cases. As illustrated in the above table, the transformer model was shown to achieve an AUC score of 0.96. In addition, the transformer model realises the lowest inference time of all the models tested. More specifically, the transformer model can reach a 3-millisecond prediction time when parallel processing is applied.

In summary, the evaluation test results illustrate that the transformer model, which can be used according to some embodiments described herein, can achieve a higher accuracy of inference (or prediction) in less time than existing techniques in a real-world scenario.

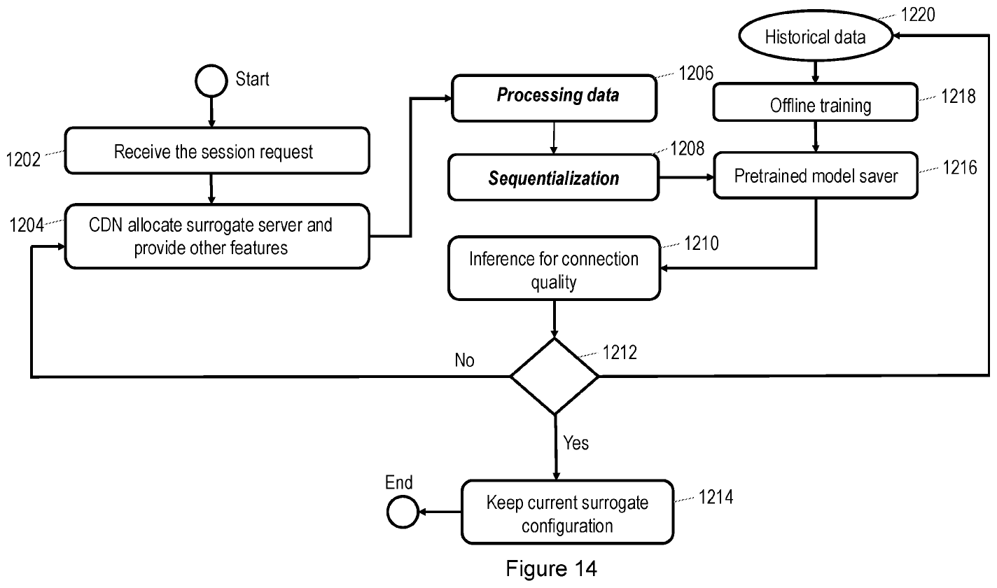

FIG. 14 illustrates a method for using a machine learning model trained in the manner described herein according to an embodiment. At block 1202 of FIG. 14, a request is received from an entity (e.g. from one or more UEs). The entity from which the request is received may be identifiable by an identifier, such as an IP address. At block 1204 of FIG. 14, a central system of a telecommunications network (e.g. a CDN) may allocate one or more network nodes (e.g. one or more surrogate servers in the case of a CDN) to the entity from which the request is received and may optionally also provide one or more other features.

At block 1206 of FIG. 14, data items may be processed and provided to a data loader (e.g. to an API of the data loader) for model inference (or prediction). At block 1208 of FIG. 14, the data items are organised into a sequence according to time. At block 1210 of FIG. 14, inference (or prediction) may be performed. For example, a pretrained machine learning model (e.g. a pretrained transformer model) may be called from a memory, such as a model saver. The pretrained machine learning model is a machine learning model that has been trained in the manner described herein. The inference (or prediction) that is performed at block 1210 of FIG. 14 can be, for example, inference (or a prediction) of a connection quality for the entity from which the request is received.

At block 1212 of FIG. 14, a decision may be made on whether or not to initiate an action in the telecommunications network, such as whether or not to re-allocate a network node (e.g. a surrogate server) in the telecommunications network. The decision can be taken based on the inference (or prediction) result. If the decision is to initiate an action, the process moves back to block 1204 of FIG. 14. On the other hand, if the decision is to not initiate an action, the process moves to block 1214 of FIG. 14 where no action is taken. For example, the same configuration of network nodes (or surrogate) servers may be kept.

At block 1216 of FIG. 14, the latest data samples may be pushed into (or stored in) memory, such as a historical data lake. At block 1218 of FIG. 14, the machine learning model training may be performed, e.g. periodically. In some embodiments, the machine learning model may be trained by way of offline training (such as offline on a back-end server). The machine learning model may be trained using historical data 1220 according to some embodiments.

There is also provided a computer program comprising instructions which, when executed by processing circuitry (such as the processing circuitry 12 of the first entity 10 described herein and/or the processing circuitry 22 of the second entity 20 described herein), cause the processing circuitry to perform at least part of the method described herein. There is provided a computer program product, embodied on a non-transitory machine-readable medium, comprising instructions which are executable by processing circuitry (such as the processing circuitry 12 of the first entity 10 described herein and/or the processing circuitry 22 of the second entity 20 described herein) to cause the processing circuitry to perform at least part of the method described herein. There is provided a computer program product comprising a carrier containing instructions for causing processing circuitry (such as the processing circuitry 12 of the first entity 10 described herein and/or the processing circuitry 22 of the second entity 20 described herein) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the first entity functionality and/or the second entity functionality described herein can be performed by hardware. Thus, in some embodiments, the first entity 10 and/or the second entity 20 described herein can be a hardware entity. However, it will also be understood that optionally at least part or all of the first entity functionality and/or the second entity functionality described herein can be virtualized. For example, the functions performed by the first entity 10 and/or second entity 20 described herein can be implemented in software running on generic hardware that is configured to orchestrate the first entity functionality and/or the second entity functionality. Thus, in some embodiments, the first entity 10 and/or second entity 20 described herein can be a virtual entity. In some embodiments, at least part or all of the first entity functionality and/or the second entity functionality described herein may be performed in a network enabled cloud. Thus, the method described herein can be realised as a cloud implementation according to some embodiments. The first entity functionality and/or second entity functionality described herein may all be at the same location or at least some of the functionality may be distributed, e.g. the first entity functionality may be performed by one or more different entities and/or the second entity functionality may be performed by one or more different entities.

It will be understood that at least some or all of the method steps described herein can be automated in some embodiments. That is, in some embodiments, at least some or all of the method steps described herein can be performed automatically. The method described herein can be a computer-implemented method.

The techniques described herein include an advantageous technique for organising data items corresponding to one or more features of a telecommunications network (e.g. user streaming data) for input into a machine learning model, an advantageous technique for training such a machining learning model (e.g. a deep transformer model), and an advantageous technique for using the trained machine learning model to perform inference on incoming data items (e.g. comprising streaming data). The inference performed according to the techniques described herein is efficient and/or can be performed in (e.g. near) real-time. The response time achieved using the techniques described herein is largely reduced compared to existing techniques. In this way, the potential for human error caused by subjective assessment is reduced.

Owing to their nature of automation and efficiency, the techniques described herein can scale up network failure detection and optimisation for all existing and future telecommunications networks, such as 5G telecommunications networks and any other generations of telecommunications network. The techniques can be broadly applied to many use cases and it will be understood that they are not limited to the example use cases described herein.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method for processing data items for use in training a machine learning model to identify a relationship between the data items, the data items corresponding to one or more features of a telecommunications network, the method comprising:
for each feature of the one or more features, organising the corresponding data items into a sequence according to time to obtain at least one sequence of data items; and
encoding a single sequence of data items comprising the at least one sequence of data items to obtain an encoded sequence of data items, the single sequence of data items is being encoded with information indicative of a position of data items in the single sequence of data items, the encoded sequence of data items being for use in training the machine learning model to identify the relationship between the data items.

2. The method as claimed in claim 1, the method comprising:
initiating the training of the machine learning model to identify the relationship between the data items in the encoded sequence of data items, wherein the relationship is identified based on the information indicative of the position of data items in the single sequence of data items.

3. The method as claimed in claim 2, the method comprising:
periodically initiating a retraining of the machine learning model to identify the relationship between the data items in the encoded sequence of data items.

4. The method as claimed in claim 1, wherein:
each feature of the one or more features has a time stamp for use in organising the corresponding data items into the sequence according to time.

5. The method as claimed in claim 1, wherein:
the information indicative of the position of data items in the single sequence of data items comprises one or both:
information indicative of a position of at least one of the data items in the single sequence of data items relative to at least one other data item in the single sequence of data items; and
information indicative of a relative distance between at least two of the data items in the single sequence of data items.

6. The method as claimed in claim 1, wherein:
the information indicative of the position of data items in the single sequence of data items is obtained by applying an exponential decay function to the single sequence of data items.

7. The method as claimed in claim 6, wherein:
applying the exponential decay function to the single sequence of data items comprises inputting values into the exponential decay function, wherein the values are indicative of the position of at least two of the data items in the single sequence of data items.

8. The method as claimed in claim 1, wherein one or both:
the method further comprises embedding the at least one sequence of data items into the single sequence of data items; and
each of the at least one sequence of data items is in the form a vector.

9. (canceled)

10. The method as claimed in claim 1, wherein one or more of:
the one or more features of the telecommunications network comprise one or more features of at least one network node of the telecommunications network;
the at least one network node comprises at least one network node that is configured to replicate one or more resources of at least one other network node; and
the data items are acquired from at least one network node of the telecommunications network.

11. (canceled)

12. (canceled)

13. The method as claimed in claim 1, wherein one or both:
the data items correspond to a user equipment served by the telecommunications network; and an identifier that identifies the user equipment is assigned to the at least one sequence of data items; and
the data items comprise information indicative of a quality of a connection between a user equipment and the telecommunications network, the connection between the user equipment and the telecommunications network being a connection between the user equipment and at least one network node of the telecommunications network.

14. (canceled)

15. (canceled)

16. The method as claimed in claim 1, the method further comprising:
initiating training of the machine learning model to predict a probability of an event occurring in the telecommunications network; and
periodically initiating a retraining of the machine learning model to predict the probability of the event occurring in the telecommunications network.

17. (canceled)

18. The method as claimed in claim 16, the method further comprising:
initiating use of the trained machine learning model to predict a probability of the event occurring in the telecommunications network.

19. The method as claimed in claim 18, the method further comprising:
if the predicted probability is above a predefined threshold, initiating an action in the telecommunications network to prevent or minimise an impact of the event, the action being an adjustment to at least one network node of the telecommunications network.

20. (canceled)

21. The method as claimed in claim 16, wherein:
the event is any one or more of:
a failure of a communication session in the telecommunications network;
a failure of a network node of the telecommunications network; and
an anomaly in a behaviour of the telecommunications network.

22. The method as claimed in claim 1, wherein:
the machine learning model is trained to identify the relationship between the data items in the encoded sequence of data items using a multi-head attention mechanism.

23. The method as claimed in claim 1, wherein:
the machine learning model is a machine learning model that is suitable for natural language processing; and
the machine learning model is a deep learning model.

24. The method as claimed in claim 23, wherein:
the deep learning model is a transformer.

25. The method as claimed in claim 1, wherein:
the telecommunications network is a content delivery network, CDN.

26. The method as claimed in claim 1, further comprising:
training the machine learning model to identify the relationship between the data items in an encoded sequence of data items.

27.-50. (canceled)

51. A first entity for processing data items for use in training a machine learning model to identify a relationship between the data items, the data items corresponding to one or more features of a telecommunications network, the first entity comprising processing circuitry configured to:
for each feature of the one or more features, organize the corresponding data items into a sequence according to time to obtain at least one sequence of data items; and
encode a single sequence of data items comprising the at least one sequence of data items to obtain an encoded sequence of data items, the single sequence of data items being encoded with information indicative of a position of data items in the single sequence of data items, the encoded sequence of data items being for use in training the machine learning model to identify the relationship between the data items.

52.-59. (canceled)
